(19) United States
(12) Patent Application Publication
(10) Pub. No.: US 2026/0095714 A1
(43) Pub. Date: Apr. 2, 2026

(54) SURROUND SOUND

(71) Applicant: Shenzhen Oceanwing Smart Innovations Technology Co., Ltd., Shenzhen (CN)

(72) Inventor: Taiyun Wu, Shenzhen (CN)

(21) Appl. No.: 19/337,261

(22) Filed: Sep. 23, 2025

(30) Foreign Application Priority Data
Sep. 30, 2024 (CN) 202411392837.5

(51) Int. Cl. H04S 7/00

(52) U.S. Cl. CPC H04S 7/302

(57) ABSTRACT

Disclosed are an audio surround playback method and apparatus and an electronic device. The method includes obtaining audio to be played, and a plurality of first playback modules; determining at least one audio track in the audio to be played and audio track data corresponding to the audio track; for each of the audio track, determining a surround playback effect and at least one second playback module from the plurality of first playback modules; determining an energy coefficient of the audio track data corresponding to each of the second playback modules; synthesizing target sound channel data according to an energy coefficient, the audio track data, and sound channel data; and controlling the first playback modules to play the corresponding target sound channel data, so as to output the audio to be played.

### CROSS-REFERENCE TO RELATED APPLICATION

The present disclosure claims priority to Chinese Patent Application No. 202411392837.5, filed on Sep. 30, 2024, the entire disclosures of which are incorporated herein by reference.

### FIELD

The present disclosure relates to the technical field of audio playback, particularly an audio surround playback method and apparatus, and an electronic device.

### BACKGROUND

In the audio playback field, surround stereo sound enhances senses of depth, presence, and space of sound through playback devices positioned at different locations and corresponding to different sound channels, causing a listener to be surrounded by a spatial sound field generated by these sound sources. This creates acoustic effects of being immersed in a concert hall or a movie theater. For example, in a 5.1 channel surround stereo system, six playback devices are typically needed to respectively play the audio signals from the central sound channel, the front left and right sound channels, the rear left and right surround sound channels, and the subwoofer sound channel (e.g., the 0.1 channel).

However, the surround effect achieved by surround stereo sound playback systems in the related art is fixed and unchangeable. They cannot implement different surround playback effects for different audio tracks individually, for example, concentrating a drum sound of a segment of audio directly at the front center, thereby adversely affecting the user experience.

### SUMMARY

The present disclosure provides an audio surround playback method and apparatus, and an electronic device to solve the technical problem that the surround effect achieved by a surround stereo sound playback system in the related art is fixed and unchangeable, and the surround stereo sound playback system is unable to separately set different surround playback effects for different audio tracks, thereby affecting the user experience.

In a first aspect, the disclosure provides an audio surround playback method including: obtaining audio to be played, and determining a plurality of first playback modules corresponding to the audio to be played; determining at least one audio track in the audio to be played and audio track data corresponding to the audio track; for each of the audio tracks, determining a surround playback effect of the audio track, and determining at least one second playback module corresponding to the audio track from the plurality of first playback modules; determining, the surround playback effect, an energy coefficient of the audio track data corresponding to each of the at least one second playback module according to the surround playback effect; synthesizing target sound channel data for each of the first playback modules according to an energy coefficient corresponding to each of the first playback modules, the audio track data corresponding to the energy coefficient, and sound channel data corresponding to each of the first playback modules, in which the energy coefficient corresponding to the first playback modules includes the energy coefficient of the audio track data corresponding to the at least one second playback module; and controlling each of the first playback modules to play corresponding target sound channel data, so as to play or output the audio to be played.

As a possible implementation, determining a surround playback effect of the audio track includes: determining whether the audio track is set for surround playback; after determining that the audio track is set for surround playback, determining whether a surround playback position is set for the audio track; after determining that a surround playback position is set for the audio track, determining the surround playback position as a surround playback effect of the audio track; and after determining that no surround playback position is set for the audio track, determining a preset position where the first playback module is located as a surround playback effect of the corresponding audio track.

As a possible implementation, the surround playback position of the audio track is set in the following method: outputting a positional relationship scenario diagram of the plurality of first playback modules through a visualization interface; after setting operation on the positional relationship scenario diagram, determining an initial surround playback position of the audio track in the positional relationship scenario diagram; and determining an actual position represented by the initial surround playback position as the surround playback position of the audio track.

As a possible implementation, the surround playback position is 1) between planes where symmetrical playback module sets are located, or 2) on a first playback module in the playback module sets, each of the playback module sets includes a first playback module corresponding to a left sound channel and a first playback module corresponding to a right sound channel, and the surround playback position comprises positions corresponding to a left sound channel audio track and a right sound channel audio track included in the audio track. The audio surround playback method further includes: determining whether the first playback module includes a sky playback module corresponding to a sky sound channel; after determining that the first playback module does not include the sky playback module, determining the first playback modules included in the playback module set as the second playback modules; and after determining that the first playback module includes the sky playback module, determining the first playback modules included in the playback module set and the sky playback module as the second playback modules.

As a possible implementation, determining an energy coefficient of the audio track data corresponding to each of the second playback modules according to the surround playback effect includes: for the second playback modules in the playback module set, determining a total distance between two opposite playback module sets where the surround playback position is located; for each of the second playback modules, determining a first distance between the surround playback position and a plane where the second playback module is located; determining a first distance ratio of the surround playback position to the second playback module according to the first distance and the total distance; subtracting the first distance ratio from a preset value to obtain a first energy coefficient; and determining an energy coefficient of the audio track data corresponding to the second playback module based on the first energy coefficient.

As a possible implementation, determining an energy coefficient of the audio track data corresponding to the second playback module based on the first energy coefficient includes: determining whether the sky playback module is present in the second playback module; after determining that the sky playback module is not present, determining the first energy coefficient as the energy coefficient of the audio track data corresponding to the second playback module; after determining that the sky playback module is present, determining a vertical distance between a plane where the sky playback module is located and a preset plane; determining a second distance between the surround play position and the plane where the sky play module is located; determining a second distance ratio of the surround playback position to the sky playback module according to the second distance and the vertical distance; subtracting the second distance ratio from a preset value to obtain a second energy coefficient; and determining the first energy coefficient and the second energy coefficient as the energy coefficient of the audio track data corresponding to the second playback module.

As a possible implementation, synthesizing target sound channel data according to an energy coefficient corresponding to the first playback module, the audio track data corresponding to the energy coefficient, and sound channel data corresponding to the first playback module includes: determining the sound channel data corresponding to the first playback module; for each audio track corresponding to the first playback module, multiplying the energy coefficient corresponding to the audio track for the first playback module by the audio track data corresponding to the energy coefficient to obtain first audio track data; inputting the first audio track data into a filter corresponding to the first playback module to obtain second audio track data; and synthesizing the sound channel data, the second audio track data, and audio track data corresponding to a preset audio track to obtain target sound channel data.

As a possible implementation, determining the sound channel data corresponding to the first playback module includes: determining a number of sound channels of the audio to be played, and a number of modules of the first playback modules; comparing the number of sound channels with the number of modules to obtain a comparison result; and converting the audio to be played according to the comparison result to obtain the sound channel data corresponding to the first playback modules.

As a possible implementation, converting the audio to be played according to the comparison result to obtain the sound channel data corresponding to the first playback modules includes: after determining the comparison result indicates that the number of sound channels is greater than the number of modules, calling a pre-trained downmix model to convert the audio to be played to convert the audio to be played into the sound channel data corresponding to the first playback modules; after determining the comparison result indicates that the number of sound channels is equal to the number of modules, determining the sound channel data corresponding to the first playback modules from the sound channel data included in the audio to be played; and after determining the comparison result indicates that the number of sound channels is less than the number of modules, calling a pre-trained upmix model to convert the audio to be played, so as to obtain the sound channel data corresponding to the first playback modules.

As a possible implementation, controlling each of the first playback modules to play corresponding target sound channel data includes: determining a third playback module with an energy coefficient less than a preset coefficient threshold from the second playback modules; controlling first playback modules other than the third playback module among the first playback modules to play corresponding target sound channel data; and controlling the third playback module to play corresponding target sound channel data after a preset duration.

In a second aspect, the disclosure provides an audio surround playback apparatus including: a first determination module configured to obtain audio to be played and determine a plurality of first playback modules corresponding to the audio to be played; a second determination module configured to determine at least one audio track in the audio to be played and audio track data corresponding to the audio track; a third determination module configured to, for each of the audio tracks, determine a surround playback effect of the audio track and determine at least one second playback module corresponding to the audio track from the plurality of first playback modules; a fourth determination module configured to determine an energy coefficient of the audio track data corresponding to each of the second playback modules according to the surround playback effect; a synthesis module configured to synthesize target sound channel data for each of the first playback modules according to an energy coefficient corresponding to the first playback module, the audio track data corresponding to the energy coefficient, and sound channel data corresponding to the first playback module, in which the energy coefficient corresponding to the first playback module includes the energy coefficient of the audio track data corresponding to the second playback module; and a control module configured to control each of the first playback modules to play corresponding target sound channel data, so as to play the audio to be played.

In a third aspect, the disclosure provides an electronic device including a processor and a memory, in which the processor is configured to execute an audio surround playback program stored in the memory to implement the audio surround playback method of any one of the first aspect.

In a fourth aspect, the disclosure provides non-transitory machine-readable medium storing instructions that, when executed by one or more processors, cause the one or more processors to perform the audio surround playback method of any one of the first aspect.

The technical solution provided by an example of the present disclosure includes: obtaining audio to be played, and determining a plurality of first playback modules corresponding to the audio to be played; determining at least one audio track in the audio to be played and audio track data corresponding to the audio track; for each of the audio tracks, determining a surround playback effect of the audio track, and determining at least one second playback module corresponding to the audio track from the plurality of first playback modules; according to the surround playback effect, determining an energy coefficient of the audio track data corresponding to each of the second playback modules; for each of the first playback modules, according to an energy coefficient corresponding to the first playback module, the audio track data corresponding to the energy coefficient, and sound channel data corresponding to the first playback module, synthesizing target sound channel data, in which the energy coefficient corresponding to the first playback module includes the energy coefficient of the audio track data corresponding to the second playback module; and controlling each of the first playback modules to play corresponding target sound channel data, to play the audio to be played.

In the technical solution, at least one audio track included in the audio to be played may be first separated, and then a desired surround playback effect may be set individually for the audio track and playback modules that achieve the surround playback effect may be determined. In some examples, different energy coefficients corresponding to audio track data can be set for the playback module according to the surround playback effect. When outputting or playing the audio to be played, the audio track data, the energy coefficient, and the sound channel data determined for each playback module can be synthesized into target sound channel data. Thus, when each playback module is controlled to play the corresponding target sound channel data, not only playback of the audio to be played can be implemented, but the surround playback effect of at least one audio track can also be achieved. This makes it possible, during the audio playback, to individually customize different surround playback effects, for the different audio tracks included in the audio, thereby improving the user experience.

### BRIEF DESCRIPTION OF THE DRAWINGS

Accompanying drawings, which are incorporated in and constitute a part of the specification, illustrate examples according to the disclosure, which together with the specification serve to explain principles of the disclosure.

In order to more clearly illustrate technical solutions in examples of the disclosure or in the related art, the drawings that need to be used in the examples or the related art are briefly introduced below, and it is apparent to those of ordinary skill in the art that other drawings can be obtained based on these drawings without inventive work.

One or more examples are illustrated by the corresponding figures in the drawings, which do not constitute a limitation of the examples. Elements with the same reference numerals in the drawings represent similar elements, and the figures in the drawings do not constitute a scale limitation unless otherwise specified.

FIG. 1 is an application scenario diagram of an audio surround playback method according to an example of the present disclosure;

FIG. 2 is another application scenario diagram of an audio surround playback method according to an example of the present disclosure;

FIG. 3 is yet another application scenario diagram of an audio surround playback method according to an example of the present disclosure;

FIG. 4 is an example flowchart of an audio surround playback method according to an example of the present disclosure;

FIG. 5 is an example flowchart of determining sound channel data of a first playback module according to an example of the present disclosure;

FIG. 6 is a flowchart of determining target sound channel data according to an example of the present disclosure;

FIG. 7 is an example flowchart of another audio surround playback method according to an example of the present disclosure;

FIG. 8 is a two-dimensional planar structure diagram of a playback module according to an example of the present disclosure;

FIG. 9A is a schematic diagram of an initial surround playback position according to an example of the present disclosure;

FIG. 9B is a schematic diagram of another initial surround playback position according to an example of the present disclosure;

FIG. 9C is a schematic diagram of yet another initial surround playback position according to an example of the present disclosure;

FIG. 9D is a schematic diagram of still another initial surround playback position according to an example of the present disclosure;

FIG. 10 is an example flowchart of yet another audio surround playback method according to an example of the present disclosure;

FIG. 11 is a schematic diagram of a surround playback position according to an example of the present disclosure;

FIG. 12 is an example block diagram of an audio surround playback apparatus according to an example of the present disclosure; and

FIG. 13 is a structure diagram of an electronic device according to an example of the present disclosure.

### DETAILED DESCRIPTION

In order to make objects, technical solutions, and advantages of examples of the disclosure clearer, the technical solutions in the examples of the disclosure will be clearly and fully described in combination with the accompanying drawings in the examples of the present disclosure. Obviously, the examples to be described are part of examples but not all examples of the disclosure. Based on the examples of the disclosure, all other examples obtained by those of ordinary skill in the art without inventive work shall fall within the scope of the disclosure.

Many different examples are disclosed below to realize different structures of the disclosure. In order to simplify the disclosure, components and arrangements of specific examples are described below. Of course, they are only exemplary and are not intended to limit the disclosure. Furthermore, the present disclosure may repeat reference numerals and/or letters in different examples. The repetition is for simplicity and clarity, and in itself does not indicate the relationship between the various examples and/or arrangements discussed.

In order to solve the technical problem in the related art that the surround effect achieved by a conventional surround stereo sound playback system is fixed and unchangeable, such that the conventional surround stereo sound playback system is unable to individually set different surround playback effects for different audio tracks, thereby affecting the user experience. The present disclosure provides an audio surround playback method and apparatus, and an electronic device. The solution involves first separating at least one audio track included in the audio to be played, and then determining a desired surround playback effect that is individually set for the audio track, and a playback module that achieves the surround playback effect. Accordingly, different energy coefficients corresponding to audio track data can be set for the playback modules based on the surround playback effect. Finally, when outputting or playing the audio to be played, the audio track data, the energy coefficient, and the sound channel data determined for each playback module can be synthesized into target sound channel data. In this way, when each playback module is controlled to play the corresponding target sound channel data, not only playback of the audio to be played can be implemented, but the surround playback effect of the at least one audio track can also be achieved, thereby enabling different surround playback effects to be individually customized for different audio tracks included in the audio, and improving the user experience.

To illustrate the audio surround playback method provided by the present disclosure, an application scenario to which the method is related is first described below by way of example.

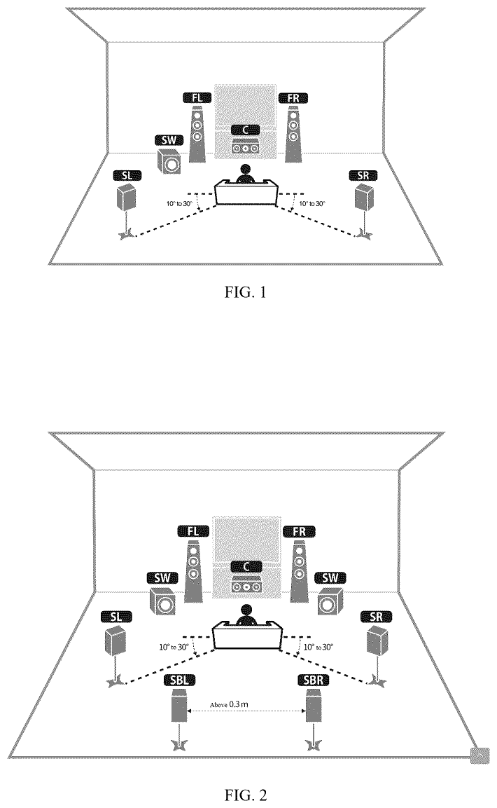

Referring to FIG. 1, FIG. 1 is an application scenario diagram of an audio surround playback method according to an example of the present disclosure. The application scenario shown in FIG. 1 is a multi-channel surround system of 5.1 channels (five sound channel playback modules and one subwoofer channel playback module). As shown in FIG. 1, the application scenario may include: a user (P), a front left sound channel playback module (FL) located at a front left side of the user (P), a front right sound channel playback module (FR) located at a front right side of the user (P), a central sound channel playback module (C) located directly in front of the user (P), a rear left channel surround playback module (SL) located at a rear left side of the user (P), a rear right channel surround playback module (SR) located at a rear right side of the user (P), and a subwoofer channel playback module (SW).

The playback modules (FL, FR, SL, SR, C, and SW) included in the application scenario shown in FIG. 1 may be playback horns, playback sound boxes, or other types of audio players, which are not limited to the examples of the present disclosure.

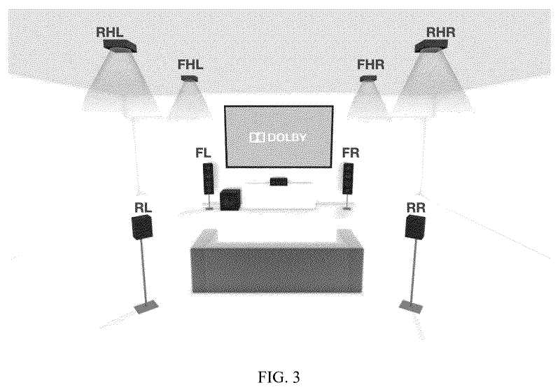

FIG. 2 is another application scenario diagram of an audio surround playback method provided by an example of the present disclosure. The application scenario shown in FIG. 2 is a multi-channel surround system of 7.2 channels (seven sound channel playback modules and two subwoofer channel playback modules). As shown in FIG. 2, the application scenario may include: a user (P), a front left sound channel playback module (FL) located at a front left side of the user (P), a front right sound channel playback module (FR) located at a front right side of the user (P), a central sound channel playback module (C) located directly in front of the user (P), a rear left channel surround playback module (SL) located at a rear left side of the user (P), a rear right channel surround playback module (SR) located at a rear right side of the user (P), two subwoofer channel playback modules (SW) located at two sides in front of the user (P), a rear left channel surround playback module (SBL) located at a directly rear left side of the user (P), and a rear right channel surround playback module (SBR) located at a directly rear right side of the user (P).

The playback modules (FL, FR, SL, SR, C, SBL, SBR, and two SWs) included in the application scenario shown in FIG. 2 may be playback horns, playback sound boxes, or other types of audio players, which are not limited to the examples of the present disclosure.

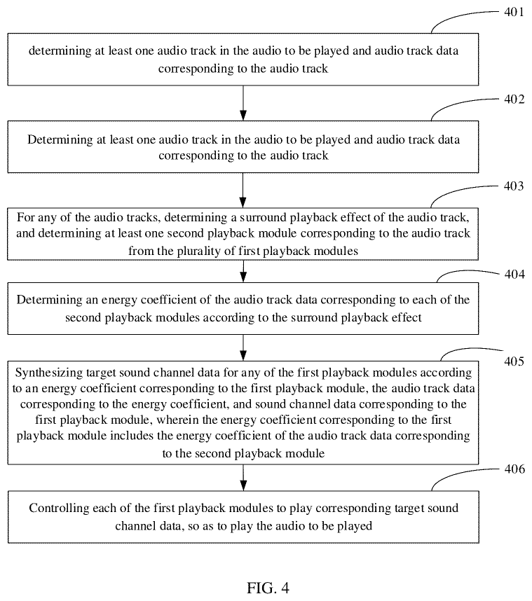

FIG. 3 is yet another application scenario diagram of an audio surround playback method according to an example of the present disclosure. The application scenario shown in FIG. 3 is a multi-channel surround system of 5.1.4 channels (five sound channel playback modules, one subwoofer channel playback module, and four sky sound channel playback modules). As shown in FIG. 3, the application scenario may include: a user (P), a front left sound channel playback module (FL) located at a front left side of the user (P), a front right sound channel playback module (FR) located at a front right side of the user (P), a central sound channel playback module (C) located directly in front of the user (P), a rear left channel surround playback module (RL) located at a rear left side of the user (P), a rear right channel surround playback module (RR) located at a rear right side of the user (P), and four sky sound channel playback modules (FHL), (FHR), (RHL), and (RHR) located above the user (P).

The playback modules (FL, FR, RL, RR, C, SW, FHL, FHR, RHL, and RHR) included in the application scenario shown in FIG. 3 may be playback horns, or playback sound boxes, or other types of audio players, which are not limited to the examples of the present disclosure.

In the related art, an audio to be played may be played in a multi-channel surround system in any of the application scenarios shown in FIG. 1 to FIG. 3. The audio to be played may be a stereo sound including a left sound channel and a right sound channel, or an audio including a plurality of sound channels.

In some examples, when the audio to be played is played through the multi-channel surround system in FIG. 1 to FIG. 3, sound channel data of the audio to be played in each playback module of the multi-channel surround system may be generally determined, and then each playback module may be controlled to play the corresponding sound channel data, thereby achieving surround playback of the audio to be played. However, the surround effect achieved by the foregoing method is fixed, and it is impossible to separately set different surround playback effects for different audio tracks, for example, concentrating a drum sound of a piece of audio directly in front, which seriously affects a user's experience.

Correspondingly, the present disclosure provides an audio surround playback method that, during the process of playing an audio, can separately customize different surround playback effects for different audio tracks included in the audio, improving the user experience.

Hereinafter, the audio surround playback method provided by the present disclosure will be further explained with reference to the accompanying drawings by way of specific examples. The examples do not constitute a limitation on the examples of the present disclosure.

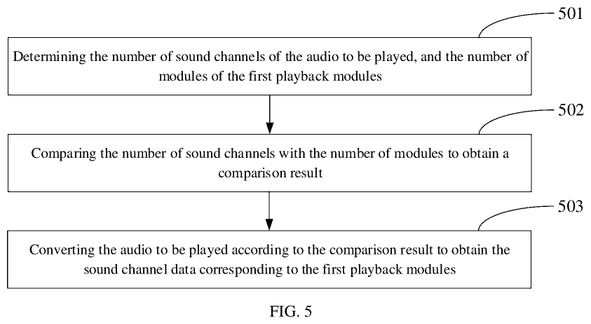

FIG. 4 is an example flowchart of an audio surround playback method provided by an example of the present disclosure. As shown in FIG. 4, the process may include the following steps 401 to 406.

Step 401: obtaining an audio to be played, and determining a plurality of first playback modules corresponding to the audio to be played.

The foregoing audio to be played is an audio ready to be played. The audio to be played may be a stereo sound, which may include left sound channel audio, right sound channel audio, or other sound channel audio, which is not limited to the examples of the present disclosure.

The foregoing first playback module is any playback module configured to play the audio to be played in a playback scenario. For example, in the scenarios shown in FIG. 1 to FIG. 3, if all playback modules included in the multi-channel surround system in any of the scenarios are configured to play the audio to be played, then all the playback modules in the multi-channel surround system can serve as the first playback modules for the audio to be played.

In an example, an execution subject of the present disclosure may be a controller of a multi-channel surround system. When the execution subject of the example of the present disclosure receives an audio through a wireless module, a Bluetooth module, or an interface, the execution subject determines the received audio as the audio to be played. When a user needs to play the audio, it may be sent to the execution subject of the example of the present disclosure through a wireless network connection, a Bluetooth connection, or an interface.

In another example, when the execution subject of the example of the present disclosure detects a voice control command given by a user, the execution subject may recognize the voice control command to identify an audio identifier of the audio to be played from the voice control command. Afterwards, the audio to be played may be obtained from a preset audio database according to the audio identifier.

In an example, after the execution subject of the example of the present disclosure obtains the audio to be played, the execution subject may determine playback modules configured to play the audio to be played (referred to as first playback modules hereinafter for ease of description), to implement playback of the audio to be played.

As an optional implementation, the execution subject of the example of the present disclosure may determine the plurality of first playback modules configured to play the audio to be played in a current multi-channel surround system according to the playback histories. For example, in recent playback histories, all playback modules included in the multi-channel surround system have played audio; therefore, it can be determined that all playback modules included in the multi-channel surround system are the first playback modules. As another example, in the playback histories, a subwoofer channel playback module in the multi-channel surround system has not played audio in multiple playback histories; then, playback modules other than the subwoofer channel playback module can be determined as the first playback modules for the audio to be played.

As another optional implementation, the execution subject of the example of the present disclosure may obtain a current running state of each connected playback module, and determine playback modules with a normal current running state as the first playback modules for the audio to be played.

Step 402: determining at least one audio track in the foregoing audio to be played and the audio track data corresponding to the foregoing audio track.

The foregoing audio track refers to an audio track corresponding to any sound source included in the audio to be played, for example, a musical instrument (an electronic drum, a piano, a bass, etc.) contained in the audio to be played. Further, the foregoing audio track may be an audio track for which a surround playback effect needs to be set individually.

The foregoing audio track data is audio data of the foregoing audio track in the audio to be played, for example, drum sound data contained in the audio to be played. The drum sound data is the audio track data corresponding to the audio track where the electronic drum is located.

In an example, the execution subject of the example of the present disclosure may input the audio to be played into a pre-trained sound source separation model, to perform sound source separation on the foregoing audio to be played through the sound source separation model, so that all audio tracks included in the audio to be played may be output by the sound source separation model, and the audio track data corresponding to each audio track can be obtained.

In another example, the execution subject of the example of the present disclosure may first determine an audio track in the audio to be played which a user presets to achieve a surround playback effect, and perform sound source separation on the audio to be played with a pre-trained sound source separation model, to determine the foregoing audio track and the audio track data corresponding to the audio track.

Step 403: for each audio track, determining a surround playback effect of the foregoing audio track, and determining at least one second playback module corresponding to the audio track from the plurality of first playback modules.

The foregoing surround playback effect refers to a surround effect achieved when playing audio track data for an audio track, which may be a surround playback position, that is, a position of the audio track heard by a user after the audio track data of the audio track is played. For example, if the audio track is a drum sound audio track, the surround playback effect set for the drum audio track may be that a drum sound perceived by the user is at the ear side, or directly in front, or at the rear, etc.

The foregoing second playback module refers to a playback module configured to achieve the surround playback effect of the foregoing audio track, that is, the foregoing second playback module plays the audio track data of the audio track, and the playback effect is the foregoing surround playback effect. It can be understood that the second playback module may be a playback module among the plurality of first playback modules corresponding to the audio to be played. Since the surround playback effect cannot be achieved by only one playback module, the number of the foregoing second playback modules is two or more, and the second playback modules have opposite relationships, for example, the front left sound channel playback module (FL) located at the front left side of the user (P), the front right sound channel playback module (FR) located at the front right side of the user (P), the rear left channel surround playback module (SL) located at the rear left side of the user (P), and the rear right channel surround playback module (SR) located at the rear right side of the user (P) in the application scenario shown in FIG. 1.

In an example, before playing the audio to be played, in order to set different surround playback effects for an audio track, the execution subject of the example of the present disclosure may determine the surround playback effect of any audio track, and determine at least one second playback module that achieves the surround playback effect of the audio track from the plurality of first playback modules.

How to specifically determine the surround playback effect of the audio track for each audio track, and how to determine at least one second playback module corresponding to the audio track from the plurality of first playback modules can be described below and will not be detailed here.

Step 404: determining an energy coefficient of the audio track data corresponding to each second playback module according to the foregoing surround playback effect.

Step 405: synthesizing target sound channel data for each first playback module according to an energy coefficient corresponding to the foregoing first playback module, the audio track data corresponding to the foregoing energy coefficient, and sound channel data corresponding to the foregoing first playback module. The energy coefficient corresponding to the foregoing first playback module includes the energy coefficient of the audio track data corresponding to the second playback module.

Step 406: controlling each of the first playback modules to play the corresponding target sound channel data, to play the foregoing audio to be played.

Hereinafter, Step 404 to Step 406 are described together.

The foregoing energy coefficient refers to a proportional coefficient between energy of the audio track data played by a second playback module and total energy of the audio track data.

The foregoing sound channel data refers to sound channel data determined for each of the first playback modules and played by the first playback module. The sound channel data is part of audio data in the audio to be played. By playing the corresponding sound channel data by each first playback module, multi-channel surround playback of the audio to be played can be achieved.

The foregoing target sound channel data is sound channel data obtained after synthesizing sound channel data initially set for each of the first playback modules, and the audio track data and the energy coefficient corresponding to achieving the surround playback effect of an audio track. By playing the corresponding target sound channel data by each of the first playback modules, multi-channel surround playback of the audio to be played and a preset surround playback effect of the audio track can be achieved.

In the example of the present disclosure, after determining the second playback module that achieves the surround playback effect of the audio track according to the surround playback effect of the audio track, the energy coefficient of the audio track data corresponding to each second playback module can be determined, so that the second playback module can play the audio track data of the audio track according to the energy coefficient, thereby achieving the surround playback effect of the audio track through the plurality of second playback modules playing the audio track data corresponding to the energy coefficients. How to specifically determine the energy coefficient of the audio track data corresponding to each second playback module can be described below and will not be detailed here.

After determining the second playback module with the surround playback effect corresponding to each audio track, and the energy coefficient of the audio track data corresponding to each second playback module, since the second playback module is determined from the first playback modules, the first playback modules may include the second playback module. Further, the determined energy coefficient of the audio track data corresponding to the second playback module is the energy coefficient of the first playback module corresponding to the second playback module.

For example, assuming that the first playback modules include a first playback module A, a first playback module B, a first playback module C, and a first playback module D. Further, assuming that for a certain audio track, the first playback module A and the first playback module C among the first playback modules are determined as a second playback module A and a second playback module C, respectively. Then, the energy coefficient corresponding to the second playback module A is the energy coefficient corresponding to the first playback module A, and the energy coefficient corresponding to the second playback module C is the energy coefficient corresponding to the first playback module C.

When playing the audio to be played, for each first playback module, target sound channel data can be synthesized according to the energy coefficient corresponding to the first playback module, the audio track data corresponding to the energy coefficient, and the sound channel data corresponding to the first playback module. The energy coefficient corresponding to the foregoing first playback module includes the energy coefficient of the audio track data corresponding to the second playback module.

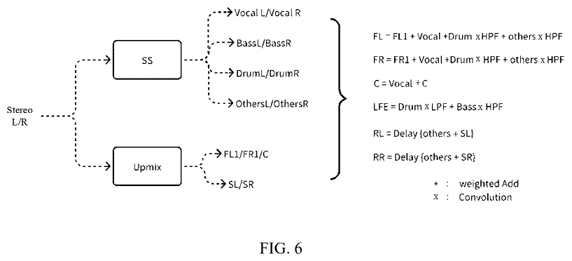

As an optional implementation, the sound channel data corresponding to the first playback module may be determined first. As an exemplary implementation, the sound channel data of the first playback module can be determined through the process shown in FIG. 5. FIG. 5 is an example flowchart of determining sound channel data of a first playback module provided by an example of the present disclosure. As shown in FIG. 5, the process may include the following steps 501 to 503.

Step 501: determining the number of sound channels of the audio to be played, and the number of modules of the first playback modules; and

Step 502: comparing the foregoing number of sound channels with the number of modules to obtain a comparison result.

Hereinafter, Step 501 and Step 502 are described together. The foregoing number of sound channels refers to a total number of all sound channels included in the audio to be played. The foregoing number of modules refers to a total number of modules of the first playback modules corresponding to the audio to be played.

In an example, the execution subject of the example of the present disclosure may determine the number of sound channels of the audio to be played and the number of modules of the first playback modules, and compare the number of sound channels with the number of modules to obtain a comparison result.

Step 503: according to the comparison result, converting the audio to be played to obtain the sound channel data corresponding to the first playback modules. In an example, when the sound channel data of the first playback modules is determined, since it is necessary to determine corresponding sound channel data for each first playback module, the execution subject of the example of the present disclosure may compare the number of sound channels of the audio to be played with the number of modules of the first playback modules, so as to convert the audio to be played according to the comparison result to obtain the sound channel data of each of the first playback modules.

For example, when the comparison result indicates that the number of sound channels is greater than the number of modules, the sound channel data included in the audio to be played is greater than the number of the first playback modules, which cannot achieve a one-to-one correspondence. Therefore, a pre-trained downmix model may be called to convert the audio to be played into the sound channel data corresponding to each of the first playback modules.

For example, when the comparison result indicates that the number of sound channels is equal to the number of modules, the sound channel data included in the audio to be played can correspond to the first playback modules one to one. Therefore, the sound channel data included in the audio to be played can correspond to the first playback modules, thereby determining the sound channel data of each of the first playback modules.

For example, when the comparison result indicates that the number of sound channels is less than the number of modules, it is necessary to increase the number of sound channels of the audio to be played. Therefore, a pre-trained upmix model may be called to convert the audio to be played, so as to obtain the sound channel data corresponding to each of the first playback modules.

Further, the foregoing upmix model may first separate preset audio track data (for example, audio track data corresponding to a human voice) and non-preset audio track data (for example, audio track data corresponding to a non-human voice) in the audio to be played. Then, the non-preset audio track data may be used to synthesize sound channel data corresponding to each sound channel playback module (such as a front left sound channel playback module, a front right sound channel playback module, a rear left sound channel playback module, and a rear right sound channel playback module in 5.1 channels) in the multi-channel surround system At the same time, the preset audio track data may be used to synthesize a central sound channel playback module. The human voice and background music in the audio to be played can be separated through the upmix model, so that the human voice is played directly in front of a user, while the background music is played surround in other sound channel playback modules, thereby improving the multi-channel surround playback effect for the audio to be played. So far, description of the process shown in FIG. 5 is completed.

Afterwards, it is known from Step 403 and Step 404 that, for each audio track, at least one second playback module corresponding to the audio track can be determined from the first playback modules to achieve the surround playback effect for the audio track. In a specific implementation, an energy coefficient corresponding to the audio track data of the audio track corresponding to each second playback module can be determined. The foregoing second playback module is determined from the first playback modules, so the energy coefficient of the audio track data corresponding to the second playback module belongs to the energy coefficient of the first playback module corresponding to the second playback module, that is, the energy coefficient corresponding to the first playback module includes the energy coefficient of the audio track data corresponding to the second playback module.

How to specifically determine the energy coefficient of the audio track data corresponding to each second playback module to obtain the energy coefficient of the corresponding first playback module can be described below and will not be detailed here.

Further, since the audio to be played may include a plurality of audio tracks, each first playback module may correspond to one energy coefficient for each audio track, and the audio track data of the audio track may correspond to the energy coefficient.

For each audio track corresponding to the first playback module, the energy coefficient corresponding to the audio track for the first playback module may be multiplied by the audio track data corresponding to the energy coefficient, to obtain first audio track data.

Thereafter, the first audio track data may be input into a filter corresponding to the first playback module to obtain second audio track data. Different first playback modules may correspond to different filters. For example, a subwoofer channel playback module may correspond to a low-pass filter, and other sound channel playback modules, especially second playback modules configured to achieve the surround playback effect of an audio track, may correspond to a high-pass filter.

Finally, the foregoing sound channel data, second audio track data, and audio track data corresponding to a preset audio track may be synthesized to obtain the target sound channel data. The audio track data corresponding to the foregoing preset audio track may be a preset audio track that does not need to achieve a surround playback effect but needs enhanced playback, for example, an audio track corresponding to a human voice.

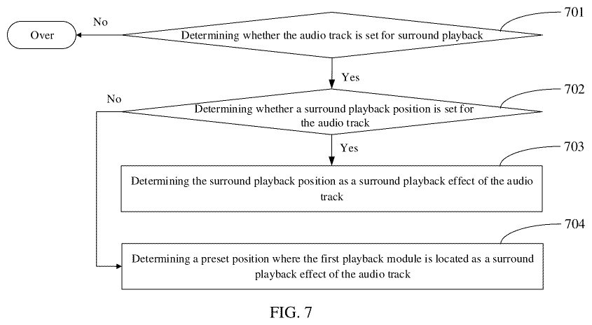

For example, FIG. 6 is a flowchart of determining target sound channel data provided by an example of the present disclosure. FIG. 6 takes a stereo sound including a left sound channel and a right sound channel as an example of the audio to be played. As shown in FIG. 6, the method may include:

First, performing sound source separation (SS) and upmix model conversion (Upmix) on the stereo sound respectively. The sound source may be separated into four audio tracks: a human voice audio track (including a left sound channel human voice audio track (Vocal L) and a right sound channel audio track (Vocal R)), a bass audio track (including a left sound channel bass audio track (Bass L) and a right sound channel bass audio track (Bass R)), a drum sound audio track (including a left sound channel drum audio track (Drum L) and a right sound channel drum audio track (Drum R)), and other audio tracks (including left sound channel other audio tracks (Others L) and right sound channel other audio tracks (Others R)).

The upmix model may convert five sound channel data of the stereo sound: front left sound channel data (FL1), front right sound channel data (FR1), central sound channel data (C), rear left sound channel data (SL), and rear right sound channel data (SR).

Assuming that a preset surround playback effect is performed on the drum audio track and other audio tracks, energy coefficients for a front left sound channel playback module and a front right sound channel playback module are both 1. Then, target sound channel data (FL) of the front left sound channel playback module is second audio track data obtained by synthesizing the following four types of audio track data: FL1, Vocal L (left sound channel human voice audio track data, i.e., first audio track data) and second audio track data obtained by multiplying Drum L (left sound channel drum audio track data) with an energy coefficient and then input into a high-pass filter (HPF), and second audio track data obtained by multiplying Others L (left sound channel other audio track data, i.e., first audio track data) with an energy coefficient (1) and then input into a high-pass filter.

At the same time, target sound channel data (FR) of the front right sound channel playback module may be obtained by synthesizing the following four types of audio track data: FR1, Vocal R (right sound channel human voice audio track data, i.e., first audio track data), second audio track data obtained by multiplying Drum R (right sound channel drum audio track data) with an energy coefficient and then input into a high-pass filter (HPF), and second audio track data obtained by multiplying others R (right sound channel other audio track data, i.e., first audio track data) with an energy coefficient (1) and then input into a high-pass filter.

Further, the central playback module does not have audio track data that needs to achieve a surround playback effect; therefore, human voice audio track data (Vocal) and central sound channel data (C) can be directly synthesized to obtain target central sound channel data (C1).

Further, target sound channel data (LFE) corresponding to the subwoofer channel playback module may be obtained by synthesizing second audio track data obtained by inputting drum audio track data (first audio track data) into a low-pass filter (HPF), and second audio track data obtained by inputting bass audio track data (Bass, i.e., first audio track data) into a low-pass filter.

Further, for the rear left sound channel playback module (RL) and the rear right sound channel playback module (RR), since an energy coefficient of the audio track data corresponding to the RL and the RR is 0, and synthesis thereof does not include the Drum. Specifically, target sound channel data of the rear left sound channel playback module (RL) may be obtained by synthesizing others and the sound channel data of the rear left sound channel playback module (SL) obtained by the upmix model, and may be played with delay during playback. For the rear right sound channel playback module, target sound channel data of the rear right sound channel playback module (RR) may be obtained by synthesizing others and the sound channel data (SR) of the rear right sound channel playback module obtained by the upmix model, and may be played with delay during playback. So far, the description of the process shown in FIG. 6 is completed.

In some examples, each of the first playback modules can be controlled to play the corresponding target sound channel data, thereby achieving the multi-channel surround playback of the audio to be played and the surround playback effect of the audio track.

As an optional implementation, a third playback module with an energy coefficient less than a preset coefficient threshold (for example, 0.5) may be determined from the foregoing second playback modules.

Afterwards, since an energy corresponding to the audio track data played by the third playback module is low, in order to enhance the surround playback effect, first playback modules other than the third playback module among the first playback modules may be controlled to play the corresponding target sound channel data. Then, after a preset duration, the third playback module is controlled to play the corresponding target sound channel data.

The technical solution provided by an example of the present disclosure includes: obtaining audio to be played, and determining a plurality of first playback modules corresponding to the audio to be played; determining at least one audio track in the audio to be played and audio track data corresponding to the audio track; for each of the audio tracks, determining a surround playback effect of the audio track, and determining at least one second playback module corresponding to the audio track from the plurality of first playback modules; according to the surround playback effect, determining an energy coefficient of the audio track data corresponding to each of the second playback modules; for each of the first playback modules, according to an energy coefficient corresponding to the first playback module, the audio track data corresponding to the energy coefficient, and sound channel data corresponding to the first playback module, synthesizing target sound channel data, in which the energy coefficient corresponding to the first playback module includes the energy coefficient of the audio track data corresponding to the second playback module; and controlling each of the first playback modules to play corresponding target sound channel data, to play the audio to be played.

In the technical solution, by first separating at least one audio track included in the audio to be played, and then determining a desired surround playback effect to be set individually for the audio track and a playback module that achieves the surround playback effect, different energy coefficients corresponding to audio track data can be set for the playback module according to the surround playback effect, and finally, when playing the audio to be played, the audio track data, the energy coefficient, and the sound channel data determined by each playback module can be synthesized into target sound channel data. Thus, when each playback module is controlled to play the corresponding target sound channel data, not only playback of the audio to be played can be implemented, but the surround playback effect of the at least one audio track can also be achieved, and during a process of playing audio, different surround playback effects can be individually customized for different audio tracks included in the audio, improving user experience.

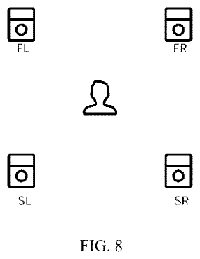

FIG. 7 is an example flowchart of another audio surround playback method provided by an example of the present disclosure. The process shown in FIG. 7, on the basis of the process shown in FIG. 4, describes how to specifically determine the surround playback effect of an audio track. As shown in FIG. 7, the process may include the following steps:

Step 701: determining whether the audio track is set for surround playback, if yes, executing Step 702; if no, ending the process;

Step 702: determining whether a surround playback position is set for the audio track, if yes, executing Step 703; if no, executing Step 704;

Step 703: determining the surround playback position as the surround playback effect of the audio track; and

Step 704: determining a preset position where the first playback module is located as the surround playback effect of the audio track.

Hereinafter, Step 701 to Step 704 are described together: In an example, the execution subject of the example of the present disclosure may, for each of the determined audio tracks, determine whether the audio track is set for surround playback.

As an optional implementation, it can be determined whether each audio track has a surround playback identifier. When it is determined that the audio track has a surround playback identifier, the audio track is set for surround playback.

As another optional implementation, a user may preset audio tracks that need to be subjected to surround playback, and incorporate the audio tracks into a preset audio track set. Based on this, the execution subject of the example of the present disclosure may determine whether the audio track is in the audio track set. If the audio track is in the audio track set, that the audio track is set for surround playback.

For example, when it is determined that the audio track is set for surround playback, it can be determined whether a surround playback position is set for the audio track.

As an optional implementation, when it is determined that a surround playback position is set for the audio track, the surround playback position is determined or set as the surround playback effect of the audio track.

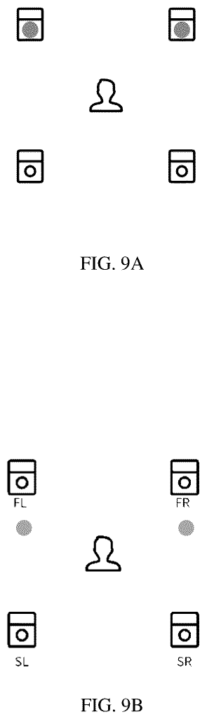

As an exemplary implementation, the execution subject of the example of the present disclosure may set the surround playback position of the audio track using the following method: first, a positional relationship scenario diagram of the plurality of first playback modules may be output through a visualization interface. The positional relationship scenario diagram may be a three-dimensional scenario diagram in a scene corresponding to a multi-channel surround system, for example, the three-dimensional scenario diagram of any of the application scenarios in FIG. 1 to FIG. 3, or a two-dimensional plan view representing a relevant positional relationship, for example, the two-dimensional plan view shown in FIG. 8. FIG. 8 is a two-dimensional planar structure diagram of a playback module provided by an example of the present disclosure. As shown in FIG. 8, the two-dimensional planar structure diagram shows a 5.1 multi-channel surround system, which may include a front left sound channel playback module, a front right sound channel playback module, a rear left sound channel playback module, and a rear right sound channel playback module corresponding to a user. Since the central sound channel playback module and the subwoofer channel playback module in the multi-channel surround system cannot achieve a surround playback effect of an audio track, the two-dimensional plan view may not include the central sound channel playback module and the subwoofer channel playback module.

A user may set the surround playback position of the audio track for the foregoing positional relationship scenario diagram. Based on this, the execution subject of the example of the present disclosure may, in response to the setting operation on the positional relationship scenario diagram, determine an initial surround playback position of the audio track in the positional relationship scenario diagram, and determine an actual position represented by the initial surround playback position as the surround playback position of the audio track.

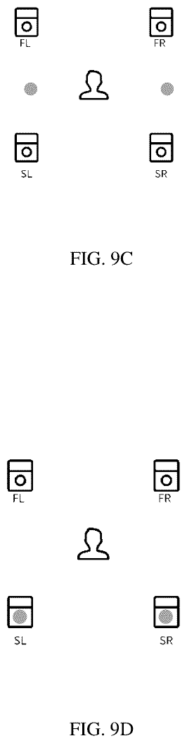

Taking the two-dimensional planar structure diagram output in FIG. 8 as an example, the two-dimensional planar structure diagram may include several setting ways as shown in FIG. 9. The foregoing surround playback position is a position of a left sound channel audio track and a right sound channel audio track. FIG. 9A is a schematic diagram of an initial surround playback position provided by an example of the present disclosure. The initial surround playback position is located at a position of a front left sound channel playback module and a front right sound channel playback module of a user. FIG. 9B is a schematic diagram of another initial surround playback position provided by an example of the present disclosure. In the initial surround playback position, the left sound channel audio track is located between a front left sound channel playback module and a rear left sound channel playback module of a user, and the right sound channel audio track is located between a front right sound channel playback module and a rear right sound channel playback module. FIG. 9C is a schematic diagram of yet another initial surround playback position provided by an example of the present disclosure. The initial surround playback module is located at two sides of the user, that is, the left sound channel audio track is located between the front left sound channel playback module and the rear left sound channel playback module, and the right sound channel audio track is located between the front right sound channel playback module and the rear right sound channel playback module. FIG. 9D is a schematic diagram of still another initial surround playback position provided by an example of the present disclosure. In the initial surround playback position, the left sound channel audio track is located at a position of the rear left sound channel playback module, and the right sound channel audio track is located at a position of the rear right sound channel playback module.

As another exemplary example, position information of each first playback module (for example, coordinate information of each playback module) may be obtained with a preset Bluetooth module or distance sensor, or the like, and output.

A user may, according to the position information of each first playback module, set surround playback position information of an audio track (for example, input coordinate information of a surround playback position through a visualization interface). The execution subject of the example of the present disclosure may, in response to a setting operation of the user, obtain the surround playback position information, and determine a position corresponding to the surround playback position information as the surround playback position of the audio track.

As another optional implementation, when it is determined that no surround playback position is set for the audio track, a position where a preset first playback module is located may be determined as the surround playback effect of the audio track. The preset first playback module may be any playback module in a multi-channel surround system. For example, an audio track may be divided into a left sound channel audio track and a right sound channel audio track, so the preset first playback module may be a pair of first playback modules, for example, a front left sound channel playback module corresponding to the left sound channel audio track, and a front right sound channel playback module corresponding to the right sound channel audio track.

In the technical solution provided by the example of the present disclosure, it is determined whether a surround playback position is set for an audio track when the audio track is set for surround playback; if yes, determining the surround playback position as the surround playback effect of the audio track; if no, determining a position where a preset first playback module is located as the surround playback effect of the audio track. In the technical solution, by presetting the surround playback position for the audio track, the surround playback position is determined as the surround playback effect of the audio track, and the surround playback position can be set arbitrarily, thereby achieving diversity in setting the surround playback effect for the audio track.

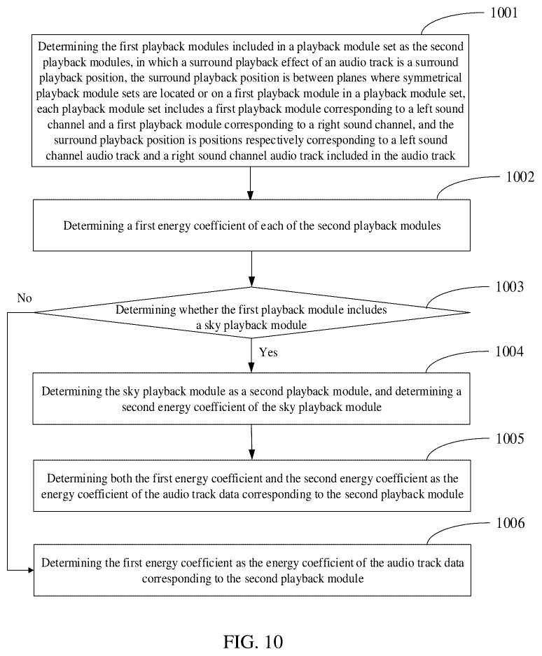

FIG. 10 is an example flowchart of yet another audio surround playback method provided by an example of the present disclosure. The process shown in FIG. 10, on the basis of the process shown in FIG. 7, describes how to specifically determine at least one second playback module corresponding to an audio track from a plurality of first playback modules, and how to determine an energy coefficient of audio track data corresponding to each second playback module. As shown in FIG. 10, the process may include the following steps 1001 to 1006.

Step 1001: determining the first playback modules included in a playback module set as the second playback modules, in which a surround playback effect of an audio track is a surround playback position, the surround playback position is between planes where symmetrical playback module sets are located or on a first playback module in a playback module set. Each playback module set includes a first playback module corresponding to a left sound channel and a first playback module corresponding to a right sound channel, and the surround playback position is positions respectively corresponding to a left sound channel audio track and a right sound channel audio track included in the audio track.

Step 1002: determining a first energy coefficient of each of the second playback modules.

Hereinafter, Step 1001 and Step 1002 are described together. It can be known from the process shown in FIG. 7 that the surround playback effect of the audio track is the surround playback position, and the surround playback position is between planes where symmetrical playback module sets are located or on a first playback module in a playback module set. Each playback module set includes a first playback module corresponding to a left sound channel and a first playback module corresponding to a right sound channel, for example, a front left sound channel playback module and a front right sound channel playback module. A symmetrical playback module set may include a front playback module and a rear playback module. In a 7.1 multi-channel system, a symmetrical playback module set may include a front playback module (a front left sound channel playback module and a front right sound channel playback module) and a middle playback module (for example, SL and SR as shown in FIG. 2), and a middle playback module and a rear playback module (for example, SBL and SBR as shown in FIG. 2). The foregoing symmetry may include complete symmetry, or symmetry of planes where two playback module sets are located.

The execution subject of the example of the present disclosure may determine the first playback modules included in the playback module set as the second playback modules corresponding to the audio track. A first energy coefficient of the second playback module can be determined.

As an optional implementation, a total distance between two opposite playback module sets where the surround playback position is located can be determined, and may refer to a total distance between planes where the two playback module sets are located.

Afterwards, for each second playback module, a distance between the surround playback position and a plane where the second playback module is located (referred to as a first distance hereinafter for ease of description) can be determined. It can be understood that if the surround playback position is located at a position where the second playback module is located, the first distance is 0.

After that, a distance ratio of the surround playback position to the second playback module (referred to as a first distance ratio hereinafter for ease of distinction) can be determined according to the first distance and the total distance. For example, the first distance may be divided by the total distance to obtain the first distance ratio.

Since the farther away from the surround playback position, the lower the energy of the played audio track data, the first distance ratio may be subtracted from a preset value (for example, 1) to obtain the first energy coefficient.

Afterwards, based on the first energy coefficient, the energy coefficient of the audio track data corresponding to the second playback module can be determined.

Step 1003: determining whether the first playback module includes a sky playback module, if yes, executing Step 1004; if no, executing Step 1006.

Step 1004: determining the sky playback module as a second playback module, and determining a second energy coefficient of the sky playback module.

Step 1005: determining both the first energy coefficient and the second energy coefficient as the energy coefficient of the audio track data corresponding to the second playback module.

Step 1006: determining the first energy coefficient as the energy coefficient of the audio track data corresponding to the second playback module.

Hereinafter, Step 1003 to Step 1006 are described together.

The foregoing sky playback module refers to a playback module located above a user's head, for example, the four sky sound channel playback modules (FHL), (FHR), (RHL), and (RHR) in the application scenario shown in FIG. 3.

In the example of the present disclosure, when determining the energy coefficient of the audio track data corresponding to the second playback module based on the first energy coefficient, it may be first determined whether a sky playback module is present in the second playback module.

For example, if no sky playback module is present, the first energy coefficient may be directly determined as the energy coefficient of the audio track data corresponding to the second playback module. At this time, the second playback module is the first playback module included in the playback module set.

For example, if a sky playback module is present, both the first playback module included in the foregoing playback module set and the sky playback module are determined as the second playback modules. Further, a second energy coefficient of the sky playback module can be determined, and both the first energy coefficient and the second energy coefficient are determined as the energy coefficient of the audio track data corresponding to the second playback module.

As an optional implementation, when determining the second energy coefficient of the sky playback module, a vertical distance between a plane where the sky playback module is located and a preset plane may be determined. The preset plane may be determined based on a height of other playback modules located on the ground. Since a user is generally in a seated state when listening to audio to be played, a lowest value in height of the surround playback effect may be a plane where the height of other playback modules located on the ground is.

Afterwards, a second distance between the surround play position and the plane where the sky play module is located may be determined. According to the second distance and the vertical distance, a second distance ratio of the surround playback position to the sky playback module can be determined. For example, a ratio of the second distance to the vertical distance may be determined as the second distance ratio. Finally, by subtracting the second distance ratio from a preset value, the second energy coefficient can be obtained.

In addition, for a multi-channel surround system where a sky playback module is present, a surround playback position of an audio track set by a user may have a certain height in space; therefore, the sky playback module may have an energy coefficient corresponding to audio track data.

It can be understood that when the second distance is zero, the surround playback position is on a plane where the sky playback module is located, and the second energy coefficient of the sky playback module is 1.

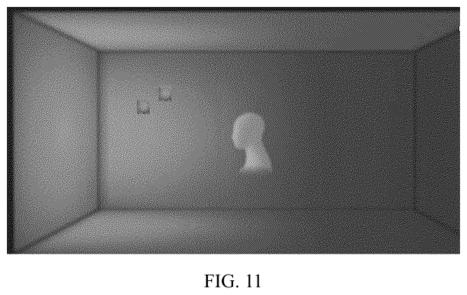

For example, taking the multi-channel surround system shown in FIG. 3 as an example, referring to FIG. 11, FIG. 11 is a schematic diagram of a surround playback position provided by an example of the present disclosure. Two points in FIG. 11 are surround playback positions. Assuming that the first distance ratio is 30% and the second distance ratio is 50%, energy audio track data of the audio track data corresponding to each second playback module may be as shown in the following formula (1):

$$[ FL , FR , RL , RR ] = [ Al * 0.7 * 0.5 , \\ Ar * 0.7 * 0.5 , Al * 0.3 * 0.5 , Ar * 0.3 * 0.5 ] \qquad Formula ( 1 )$$

$$[ FHL , FHR , RHL , RHR ] = [ Al * 0.7 * 0.5 , \\ Ar * 0.7 * 0.5 , Al * 0.3 * 0.5 , Ar * 0.3 * 0.5 ]$$

wherein, Al is left sound channel audio track data of the corresponding audio track, and Ar is right sound channel audio track data of the corresponding audio track. FL is a front left sound channel playback module, FR is a front right sound channel playback module at a front right side, RL is a rear left channel surround playback module located at a rear left side of the user (P), RR is a rear right channel surround playback module located at a rear right side of the user (P), and FHL, FHR, RHL, and RHR are four sky sound channel playback modules located above the user (P).

The technical solution provided by the example of the disclosure includes: determining the first playback modules included in a playback module set as the second playback modules, in which a surround playback effect of an audio track is a surround playback position, the surround playback position is between planes where symmetrical playback module sets are located or on a first playback module in a playback module set, each playback module set includes a first playback module corresponding to a left sound channel and a first playback module corresponding to a right sound channel, and the surround playback position is positions respectively corresponding to a left sound channel audio track and a right sound channel audio track included in the audio track; determining a first energy coefficient of each of the second playback modules; determining whether the first playback module includes a sky playback module, if yes, determining the sky playback module as a second playback module, and determining a second energy coefficient of the sky playback module; determining both the first energy coefficient and the second energy coefficient as the energy coefficient of the audio track data corresponding to the second playback module; and if no, determining the first energy coefficient as the energy coefficient of the audio track data corresponding to the second playback module. The technical solution determines an energy coefficient of a playback module in different dimensions such as a horizontal direction and a vertical direction, respectively, thereby more accurately determining the energy coefficient of each second playback module.

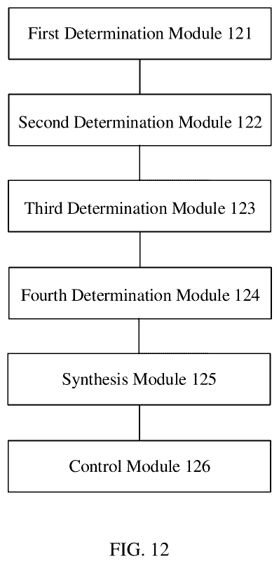

FIG. 12 is an example block diagram of an audio surround playback apparatus provided by an example of the present disclosure. As shown in FIG. 12, the apparatus may include:
a first determination module (121) configured to obtain audio to be played and determine a plurality of first playback modules corresponding to the audio to be played;
a second determination module (122) configured to determine at least one audio track in the audio to be played and audio track data corresponding to the audio track;
a third determination module (123) configured to, for each of the audio tracks, determine a surround playback effect of the audio track and determine at least one second playback module corresponding to the audio track from the plurality of first playback modules;
a fourth determination module (124) configured to determine an energy coefficient of the audio track data corresponding to each of the second playback modules according to the surround playback effect;
a synthesis module (125) configured to synthesize target sound channel data for each of the first playback modules according to an energy coefficient corresponding to the first playback module, the audio track data corresponding to the energy coefficient, and sound channel data corresponding to the first playback module, in which the energy coefficient corresponding to the first playback module includes the energy coefficient of the audio track data corresponding to the second playback module; and
a control module (126) configured to control each of the first playback modules to play corresponding target sound channel data, so as to output or play the audio to be played.

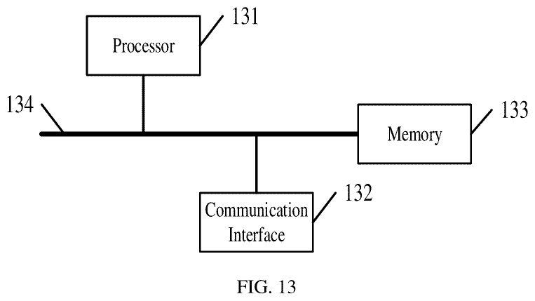

FIG. 13 is a structure diagram of an electronic device provided by an example of the present disclosure. The electronic device includes a processor (131), a communication interface (132), a memory (133), and a communication bus (134), in which the processor (131), the communication interface (132), and the memory (133) complete communication with each other through the communication bus (134); the memory (133) is configured to store a computer program; and in an example of the present disclosure, the processor (131) is configured to, when executing the program stored in the memory (133), implement the audio surround playback method provided by any one of the foregoing method examples, including:
obtaining audio to be played, and determining a plurality of first playback modules corresponding to the audio to be played;
determining at least one audio track in the audio to be played and audio track data corresponding to the audio track;
for each of the audio tracks, determining a surround playback effect of the audio track, and determining at least one second playback module corresponding to the audio track from the plurality of first playback modules;
determining an energy coefficient of the audio track data corresponding to each of the second playback modules according to the surround playback effect;
synthesizing target sound channel data for each of the first playback modules according to an energy coefficient corresponding to the first playback module, the audio track data corresponding to the energy coefficient, and sound channel data corresponding to the first playback module, in which the energy coefficient corresponding to the first playback module includes the energy coefficient of the audio track data corresponding to the second playback module; and
controlling each of the first playback modules to play corresponding target sound channel data, so as to output or play the audio to be played.

An example of the present disclosure further provides a storage medium on which a computer program is stored. When executed by a processor, the computer program implements the steps of the audio surround playback method provided by any one of the foregoing method examples.

The apparatus examples described above are merely exemplary, where units described as separate parts may or may not be physically separate, and parts displayed as units may or may not be physical units, that is, may be located in one position or distributed on a plurality of grid units. Part or all of the modules may be selected according to actual needs to achieve the objects of the example solutions.

Through the text of the foregoing examples, a person skilled in the art may clearly understand that the examples may be implemented by software in combination with a universal hardware platform, or by hardware. Based on such understanding, the above technical solutions essentially or the part contributing to the related art may be embodied in the form of a software product. The software product may be stored in a computer readable storage medium, such as a ROM/RAM, a magnetic disk, or an optical disk. The computer readable storage medium includes several instructions for instructing a computer device (which may be a personal computer, a server, a grid device, or the like) to execute the methods described in the examples or in some parts of the examples.

It should be understood that the terms used herein are only for the purpose of describing specific exemplary examples and are not intended to be limiting. Unless the context clearly indicates otherwise, the singular forms “a”, “an” and “the” as used herein can also mean including plural forms. The terms “include”, “contain”, “comprise” and “have” are inclusive and thus indicate the presence of features, steps, operations, elements and/or components described, but do not exclude the presence or addition of one or more other features, steps, operations, elements, components, and/or combinations thereof. The method steps, procedures, and operations described herein are not interpreted as necessarily requiring them to be executed in the specific order described, unless the execution order is explicitly indicated. It should also be understood that additional or alternative steps may be used.

The foregoing is only the description of examples of the disclosure to enable a person skilled in the art to understand or implement the disclosure. Various modifications to these examples will be apparent to a person skilled in the art, and general principles defined herein may be implemented in other examples without departing from the spirit or scope of the disclosure. Thus, the disclosure is not limited to the examples shown herein, but conforms to the widest scope consistent with the principles and novel characteristics applied herein.

What is claimed is:

1. An audio surround playback method comprising:
determining a plurality of first playback modules corresponding to an audio to be played;
determining at least one audio track in the audio to be played and audio track data corresponding to the at least one audio track;
determining a surround playback effect of each of the at least one audio track, and at least one second playback module corresponding to each of the at least one audio track from the plurality of first playback modules;
determining, based on the surround playback effect, an energy coefficient of the audio track data corresponding to each of the at least one second playback module;
synthesizing target sound channel data for each of the plurality of first playback modules based on:
an energy coefficient corresponding to each of the plurality of first playback module,
the audio track data corresponding to the energy coefficient, and
sound channel data corresponding to each of the plurality of first playback modules,
wherein the energy coefficient corresponding to the first playback module includes the energy coefficient of the audio track data corresponding to the at least one of second playback module; and
causing output of the audio to be played by controlling each of the plurality of first playback modules to play the corresponding target sound channel data.

2. The method of claim 1, wherein determining the surround playback effect of each of the at least one audio track comprises:
determining whether the at least one audio track is set for surround playback;
after determining that the at least one audio track is set for surround playback, determining whether a surround playback position is set for the at least one audio track;
after determining that the surround playback position is set for the at least one audio track, setting the surround playback position as the surround playback effect of the at least one audio track; and
after determining that no surround playback position is set for the at least one audio track, setting a preset position where each of the first plurality of playback modules is located as the surround playback effect of the at least one audio track.

3. The method of claim 2, wherein setting the surround playback position comprises:
outputting, via a visualization interface, a positional relationship scenario diagram of the plurality of first playback modules;
after setting operation on the positional relationship scenario diagram, determining an initial surround playback position of the at least one audio track in the positional relationship scenario diagram; and
determining an actual position represented by the initial surround playback position as the surround playback position of the at least one audio track.

4. The method of claim 2, wherein the surround playback position is between planes where symmetrical playback module sets are located or on a first playback module in the symmetrical playback module sets, each of the symmetrical playback module sets includes a first playback module corresponding to a left sound channel and a first playback module corresponding to a right sound channel, and the surround playback position comprises positions corresponding to a left sound channel audio track and a right sound channel audio track included in the at least one audio track;
wherein the method further comprises:
determining whether the first playback module comprises a sky playback module corresponding to a sky sound channel;
after determining that the first playback module does not comprise the sky playback module, setting the first playback modules included in the symmetrical playback module sets as the at least one second playback module; and
after determining that the first playback module comprises the sky playback module, setting the first playback modules included in the symmetrical playback module sets and the sky playback module as the at least one second playback module.

5. The method of claim 4, wherein determining the energy coefficient of the audio track data comprises:
for each of the at least one second playback modules in the playback module set, determining a total distance between two opposite playback module sets where the surround playback position is located;
for each of the at least one second playback modules, determining a first distance between the surround playback position and a plane where the second playback module is located;
determining a first distance ratio of the surround playback position to each of the at least one second playback module according to the first distance and the total distance;
subtracting the first distance ratio from a preset value to obtain a first energy coefficient; and
determining the energy coefficient of the audio track data corresponding to each of the at least one second playback module based on the first energy coefficient.

6. The method of claim 5, wherein determining the energy coefficient of the audio track data comprises:
determining whether the sky playback module is present in the second playback module;
when the sky playback module is not present, determining the first energy coefficient as the energy coefficient of the audio track data corresponding to each of the at least one second playback module;
when the sky playback module is present, determining a vertical distance between a plane where the sky playback module is located and a preset plane;
determining a second distance between the surround play position and the plane where the sky play module is located;
determining a second distance ratio of the surround playback position to the sky playback module according to the second distance and the vertical distance;
subtracting the second distance ratio from a preset value to obtain a second energy coefficient; and
determining the first energy coefficient and the second energy coefficient as the energy coefficient of the audio track data corresponding to each of the at least one second playback module.

7. The method of claim 1, wherein synthesizing the target sound channel data comprises:
determining the sound channel data corresponding to the plurality of first playback modules;
for each audio track corresponding to each of the plurality of first playback modules, multiplying the energy coefficient corresponding to the audio track for the corresponding first playback module by the audio track data corresponding to the energy coefficient to obtain first audio track data;
inputting the first audio track data into a filter for the corresponding first playback module to obtain second audio track data; and
synthesizing the sound channel data, the second audio track data, and audio track data corresponding to a preset audio track to obtain the target sound channel data.

8. The method of claim 7, wherein determining the sound channel data corresponding to the plurality of first playback modules comprises:
determining a number of sound channels of the audio to be played, and a number of modules of the plurality of first playback modules;
comparing the number of sound channels with the number of modules to obtain a comparison result; and
converting the audio to be played according to the comparison result to obtain the sound channel data corresponding to the plurality of first playback modules.

9. The method of claim 7, wherein converting the audio to be played according to the comparison result comprises:
after determining the comparison result indicates that the number of sound channels is greater than the number of modules, calling a pre-trained downmix model to convert the audio to be played into the sound channel data corresponding to the plurality of first playback modules;
after determining the comparison result indicates that the number of sound channels is equal to the number of modules, determining the sound channel data corresponding to the plurality of first playback modules from the sound channel data included in the audio to be played; and
after determining the comparison result indicates that the number of sound channels is less than the number of modules, calling a pre-trained upmix model to convert the audio to be played, so as to obtain the sound channel data corresponding to the first playback modules.

10. The method of claim 1, wherein controlling each of the plurality of first playback modules to play corresponding target sound channel data comprises:
determining a third playback module with an energy coefficient less than a preset coefficient threshold from the at least one second playback module;
controlling the plurality of first playback modules other than the third playback module among the plurality of first playback modules to play corresponding target sound channel data; and
controlling the third playback module to play corresponding target sound channel data after a preset duration.

11. An audio surround playback apparatus comprising:
a first determination module configured to determine a plurality of first playback modules corresponding to an audio to be played;
a second determination module configured to determine at least one audio track in the audio to be played and audio track data corresponding to the at least one audio track;
a third determination module configured to determine a surround playback effect of each of the at least one audio track and determine at least one second playback module corresponding to each of the at least one audio track from the plurality of first playback modules;
a fourth determination module configured to determine, based on the surround playback effect, an energy coefficient of the audio track data corresponding to each of the at least one second playback module according to the surround playback effect;
a synthesis module configured to synthesize target sound channel data for each of the plurality of first playback modules based on:
an energy coefficient corresponding to each of the plurality of first playback module,
the audio track data corresponding to the energy coefficient, and
sound channel data corresponding to each of the plurality of first playback modules,
wherein the energy coefficient corresponding to the first playback module includes the energy coefficient of the audio track data corresponding to the at least one of second playback module; and
a control module configured to cause output of the audio to be played by controlling each of the plurality of first playback modules to play the corresponding target sound channel data.

12. The audio surround playback apparatus of claim 11, wherein the second determination module is further configured to:
determine whether the at least one audio track is set for surround playback;
after determining that the at least one audio track is set for surround playback, determine whether a surround playback position is set for the at least one audio track;
after determining that the surround playback position is set for the at least one audio track, set the surround playback position as the surround playback effect of the at least one audio track; and
after determining that no surround playback position is set for the at least one audio track, set a preset position where each of the first plurality of playback modules is located as the surround playback effect of the at least one audio track.

13. The audio surround playback apparatus claim 12, wherein the second determination module is configured to set the surround playback position by:
outputting, via a visualization interface, a positional relationship scenario diagram of the plurality of first playback modules;
after setting operation on the positional relationship scenario diagram, determining an initial surround playback position of the at least one audio track in the positional relationship scenario diagram; and
determining an actual position represented by the initial surround playback position as the surround playback position of the at least one audio track.

14. The audio surround playback apparatus of claim 12, wherein the surround playback position is between planes where symmetrical playback module sets are located or on a first playback module in the symmetrical playback module sets, each of the symmetrical playback module sets includes a first playback module corresponding to a left sound channel and a first playback module corresponding to a right sound channel, and the surround playback position comprises positions corresponding to a left sound channel audio track and a right sound channel audio track included in the at least one audio track;
wherein the second determination module is further configured to:
determine whether the first playback module comprises a sky playback module corresponding to a sky sound channel;
after determining that the first playback module does not comprise the sky playback module, set the first playback modules included in the symmetrical playback module sets as the at least one second playback module; and
after determining that the first playback module comprises the sky playback module, set the first playback modules included in the symmetrical playback module sets and the sky playback module as the at least one second playback module.

15. The audio surround playback apparatus of claim 14, wherein the fourth determination module is further configured to determine the energy coefficient of the audio track data by:
for each of the at least one second playback modules in the playback module set, determining a total distance between two opposite playback module sets where the surround playback position is located;
for each of the at least one second playback modules, determining a first distance between the surround playback position and a plane where the second playback module is located;
determining a first distance ratio of the surround playback position to each of the at least one second playback module according to the first distance and the total distance;
subtracting the first distance ratio from a preset value to obtain a first energy coefficient; and
determining the energy coefficient of the audio track data corresponding to each of the at least one second playback module based on the first energy coefficient.

16. The audio surround playback apparatus of claim 15, wherein the fourth determination module is further configured to determine the energy coefficient of the audio track data by:
determining whether the sky playback module is present in the second playback module;
when the sky playback module is not present, determining the first energy coefficient as the energy coefficient of the audio track data corresponding to each of the at least one second playback module;
when the sky playback module is present, determining a vertical distance between a plane where the sky playback module is located and a preset plane;
determining a second distance between the surround play position and the plane where the sky play module is located;
determining a second distance ratio of the surround playback position to the sky playback module according to the second distance and the vertical distance;
subtracting the second distance ratio from a preset value to obtain a second energy coefficient; and
determining the first energy coefficient and the second energy coefficient as the energy coefficient of the audio track data corresponding to each of the at least one second playback module.

17. The audio surround playback apparatus of claim 11, wherein the synthesis module is configured to synthesize the target sound channel data by:
determining the sound channel data corresponding to the plurality of first playback modules;
for each audio track corresponding to each of the plurality of first playback modules, multiplying the energy coefficient corresponding to the audio track for the corresponding first playback module by the audio track data corresponding to the energy coefficient to obtain first audio track data;
inputting the first audio track data into a filter for the corresponding first playback module to obtain second audio track data; and
synthesizing the sound channel data, the second audio track data, and audio track data corresponding to a preset audio track to obtain target sound channel data.

18. The audio surround playback apparatus of claim 17, wherein the second determination module is further configured to determine the sound channel data corresponding to the plurality of first playback modules by:
determining a number of sound channels of the audio to be played, and a number of modules of the plurality of first playback modules;
comparing the number of sound channels with the number of modules to obtain a comparison result; and
converting the audio to be played according to the comparison result to obtain the sound channel data corresponding to the plurality of first playback modules.

19. The audio surround playback apparatus of claim 17, wherein the second determination module is further configured to convert the audio to be played according to the comparison result by:
after determining the comparison result indicates that the number of sound channels is greater than the number of modules, calling a pre-trained downmix model to convert the audio to be played into the sound channel data corresponding to the plurality of first playback modules;
after determining the comparison result indicates that the number of sound channels is equal to the number of modules, determining the sound channel data corresponding to the plurality of first playback modules from the sound channel data included in the audio to be played; and
after determining the comparison result indicates that the number of sound channels is less than the number of modules, calling a pre-trained upmix model to convert the audio to be played, so as to obtain the sound channel data corresponding to the first playback modules.

20. A non-transitory machine-readable medium storing instructions that, when executed by one or more processors, cause the one or more processors to perform steps comprising:
determining a plurality of first playback modules corresponding to an audio to be played;
determining at least one audio track in the audio to be played and audio track data corresponding to the at least one audio track;
determining a surround playback effect of each of the at least one audio track, and determining, from the plurality of first playback modules, at least one second playback module corresponding to each of the at least one audio track;
determining, based on the surround playback effect, an energy coefficient of the audio track data corresponding to each of the at least one second playback module;
synthesizing target sound channel data for each of the plurality of first playback modules based on:
an energy coefficient corresponding to each of the plurality of first playback module,
the audio track data corresponding to the energy coefficient, and
sound channel data corresponding to each of the plurality of first playback modules,
wherein the energy coefficient corresponding to the first playback module includes the energy coefficient of the audio track data corresponding to the at least one of second playback module; and
causing output of the audio to be played by controlling each of the plurality of first playback modules to play the corresponding target sound channel data.
